(19) United States
(12) Patent Application Publication
(10) Pub. No.: US 2013/0250802 A1
(43) Pub. Date: Sep. 26, 2013

(54) REDUCING CABLING COSTS IN A DATACENTER NETWORK

(71) Applicants: Praveen Yalagandula, San Francisco, CA (US); Rachit Agarwal, Urbana, IL (US); Jayaram Mudigonda, San Jose, CA (US); Jeffrey Clifford Mogul, Menlo Park, CA (US)

(72) Inventors: Praveen Yalagandula, San Francisco, CA (US); Rachit Agarwal, Urbana, IL (US); Jayaram Mudigonda, San Jose, CA (US); Jeffrey Clifford Mogul, Menlo Park, CA (US)

(21) Appl. No.: 13/430,673

(22) Filed: Mar. 26, 2012

(51) Int. Cl. H04L 12/28

(52) U.S. Cl. 370/254

(57) ABSTRACT

A datacenter network, method, and non-transitory computer readable medium for reducing cabling costs in the datacenter network are provided. The datacenter network is represented by a network topology that interconnects a plurality of network elements and a physical topology that is organized into a plurality of physical elements and physical units. A network design module assigns network elements to the plurality of physical elements and physical units based on a hierarchical partitioning of the physical topology and a matching hierarchical partitioning of the network topology that reduces costs of cables used to interconnect the network elements in the physical topology.

### BACKGROUND

The design of a datacenter network that minimizes cost and satisfies performance requirements is a hard problem with a huge solution space. A network designer has to consider a vast number of choices. For example, there are a number of network topology families that can be used, such as FatTree, HyperX, BCube, DCell, and CamCube, each with numerous parameters to be decided on, such as the number of interfaces per switch, the size of the switches, and the network cabling interconnecting the network (e.g., cables and connectors such as optical, copper, 1G, 10G, or 40G). In addition, network designers also need to consider the physical space where the datacenter network is located, such as, for example, a rack-based datacenter organized into rows of racks.

A good fraction of datacenter network costs can be attributed to the network cabling interconnecting the network: as much as 34% of a datacenter network cost (e.g., several millions of dollars for an 8K server network). The price of a network cable increases with its length—the shorter the cable, the cheaper it is. Cheap copper cables have a short limited maximum distance span of about 10 meters because of signal degradation. For larger distances, expensive cables such as, for example, optical-fiber cables, may have to be used.

Traditionally, network designers manually designed the network cabling layout, but this process is slow and cumbersome and can result in suboptimal solutions. Also this may be feasible only when deciding a cabling layout for one or few network topologies but quickly becomes infeasible when poring through a large number of network topologies. Designing a datacenter network while reducing cabling costs is one of the key challenges laced by network designers today.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 is a schematic diagram illustrating an example environment in which the various embodiments may be implemented;

FIG. 2 is a schematic diagram illustrating an example of a physical topology;

FIGS. 3A-B illustrate examples of network topologies;

FIG. 4A illustrates an example physical topology graph for representing a physical topology;

FIG. 4B illustrates an example network topology graph for representing a network topology;

FIG. 5 is a flowchart for reducing cabling costs in a datacenter network according to various embodiments;

FIG. 6 is a flowchart for hierarchically partitioning a physical topology according to various embodiments;

FIG. 7 is an example of hierarchical partitioning of a physical topology represented by the physical topology graph of FIG. 4A;

FIG. 8 is a flowchart for hierarchically partitioning a network topology according to various embodiments;

FIG. 9 illustrates an example of a hierarchical partitioning of a network topology matching the hierarchical partitioning of a physical topology of FIG. 7;

FIG. 10 is a flowchart for the placement of network elements from the network topology partitions in the physical topology partitions;

FIG. 11 is a flowchart for identifying cables to connect the network elements placed in the physical partitions; and

FIG. 12 is a block diagram of an example component for implementing the network design module of FIG. 1 according to various embodiments.

### DETAILED DESCRIPTION

A method, system, and non-transitory computer readable medium for reducing cabling costs in a datacenter network are disclosed. As generally described herein, a datacenter network refers to a network of network elements (e.g., switches, servers, etc.) and links configured in a network topology. The network topology may include, for example, FatTree, HyperX, BCube, DCell, and CamCube topologies, among others.

In various embodiments, a network design module maps a network topology into a physical topology (i.e., into an actual physical structure) such that the total cabling costs of the network are minimized. The physical topology may include, but is not limited to, a rack-based datacenter organized into rows of racks, a circular-based datacenter, or any other physical topology available for a datacenter network.

As described in more detail herein below, the network design module employs hierarchical partitioning to maximize the use of shorter and hence cheaper cables. The physical topology is hierarchically partitioned into k levels such that network elements within the same partition at a given level t can be wired with the l-th shortest cable. Likewise, a network topology is hierarchically partitioned into k levels such that each partition of the network topology at a level l can be placed in a level l partition of the physical topology. While partitioning the network topology at any level, the number of links (and therefore, cables) that go between any two partitions is minimized. This ensures that the number of shorter cables used is maximized.

It is appreciated that embodiments described herein below may include various components and features. Some of the components and features may be removed and/or modified without departing from a scope of the method, system, and non-transitory computer readable medium for reducing cabling costs in a datacenter network. It is also appreciated that, in the following description, numerous specific details are set forth to provide a thorough understanding of the embodiments. However, it is appreciated that the embodiments may be practiced without limitation to these specific details. In other instances, well known methods and structures may not be described in detail to avoid unnecessarily obscuring the description of the embodiments. Also, the embodiments may be used in combination with each other.

Reference in the specification to “an embodiment,” “an example” or similar language means that a particular feature, structure, or characteristic described in connection with the embodiment or example is included in at least that one example, but not necessarily in other examples. The various instances of the phrase “in one embodiment” or similar phrases in various places in the specification are not necessarily all referring to the same embodiment. As used herein, a component is a combination of hardware and software executing on that hardware to provide a given functionality.

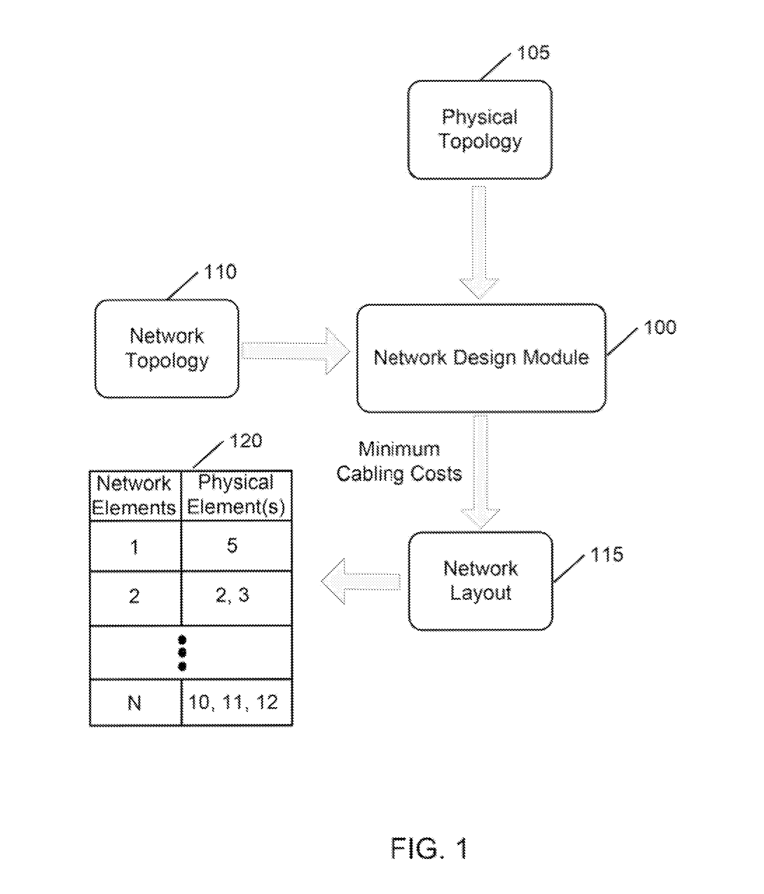

Referring now to FIG. 1, a schematic diagram illustrating an example environment in which the various embodiments may be implemented is described. Network design module 100 takes a physical topology 105 and a network topology 110 and determines a network layout 115 that minimizes the network cabling costs. The physical topology 105 may be organized into a number of physical elements (e.g., racks, oval regions, etc.), with each physical element composed of a number of physical units (e.g., rack units, oval segments, etc.). The network topology 110 may be any topology for interconnecting a number of servers, switches, and other network elements, such as FatTree HyperX, and BCube, among others.

The network layout 115 is an assignment 120 of network elements to physical unit(s) or element(s) in the physical topology 105. For example, a network element 1 may be assigned to physical element 5, a network element 2 may be assigned to physical units 2 and 3, and a network element N may be assigned to physical units 10, 11, and 12. The number of physical elements or units assigned to each network element depends on various factors, such as for example, the size of the network elements relative to each physical element or unit, how the cabling between each physical element is placed in the network, the types of cables that may be used and their costs. The resulting network layout 115 is such that the total cabling costs in the network are minimized.

It is appreciated that the network design module 100 may determine a network layout 115 that minimizes the total cabling costs for any available physical topology 105 and any available network topology 110. That is, a network designer may employ the network design module 100 to determine which network topology and which physical topology may be selected to keep the cabling costs to a minimum.

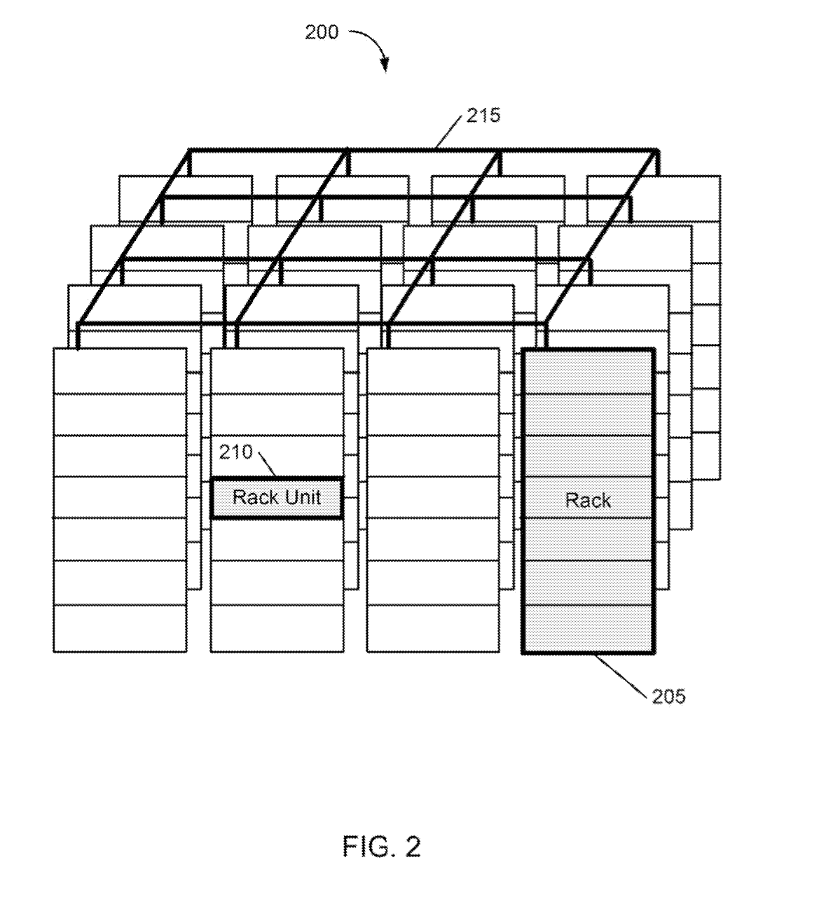

An example of a physical topology is illustrated in FIG. 2. Physical topology 200 is an example of a rack-based datacenter that is organized into rows of physical elements known as racks, such as rack 205. Each rack may have a fixed width (e.g., 19 inches) and is divided on the vertical axis into physical units known as rack units, such as rack unit 210. Each rack unit may also have a fixed height (e.g., 1.75 inches). Rack heights may vary from 16 to 50 rack units, with most common rack-based datacenters having rack heights of 42 rack units. Typical rack-based datacenters are designed so that cables between rack units in a rack or cables exiting a rack run in a plenum space on either side of the rack. This way cables are run from a face plate to the sides on either end, thereby ensuring that cables do not block the air flow inside a rack and hence do not affect cooling.

While racks in a row are placed next to each other, two consecutive rows are separated either by a “cold aisle” or by a “hot aisle”. A cold aisle is a source of cool air and a hot aisle is a sink for heated air. Several considerations may govern the choice of aisle widths, but generally the cold aisle is designed to be at least 4 feet wide and the hot aisle is designed to be at least 3 feet wide. In modern rack-based datacenters, network cables do not run under raised floors, because it becomes too painful to trace the underfloor cables when working on them. Therefore, cables running between racks are placed in ceiling-hung trays (e.g., cross tray 215 for every column of racks) which are a few feet above the racks. One tray runs directly above each row of racks, but there are relatively few trays running between rows (not shown) because too many cross trays may restrict air flow.

Given a rack-based datacenter, to place and connect network elements (e.g., servers, switches, etc.) at two different rack units, u₁ and u₂, one has to run a cable as follows. First, the cable is run from the faceplate of the network element at u₁ to the side of the rack. If both u₁ and u₂ are in the same rack, then the cable need not exit the rack and just need to be laid out to the rack unit u₂ and then to the faceplate of the network element at u₂. If u₁ and u₂ are in two different racks, then the cable has to exit the rack u₁ and run to the ceiling-hung cable tray. The cable then needs to be laid on the cable tray to reach the destination rack where u₂ is located. Since cross trays may not run on every rack, the distance between the top of two racks can be more than a simple Manhattan distance. Once at the destination rack, the cable is run down from the cable tray and run on the side to the rack unit u₂.

It is appreciated by one skilled in the art that the physical topology 200 is shown as a rack-based topology for illustration purposes only. Physical topology 200 may have other configurations, such as, for example, an oval shaped configuration in which physical elements may be represented as oval regions and physical units inside a physical element may be represented as oval segments. In either case, the distance between two physical elements or units in the physical topology may be computed as a mathematical function d(·) that takes into account the geometric characteristics of the physical topology.

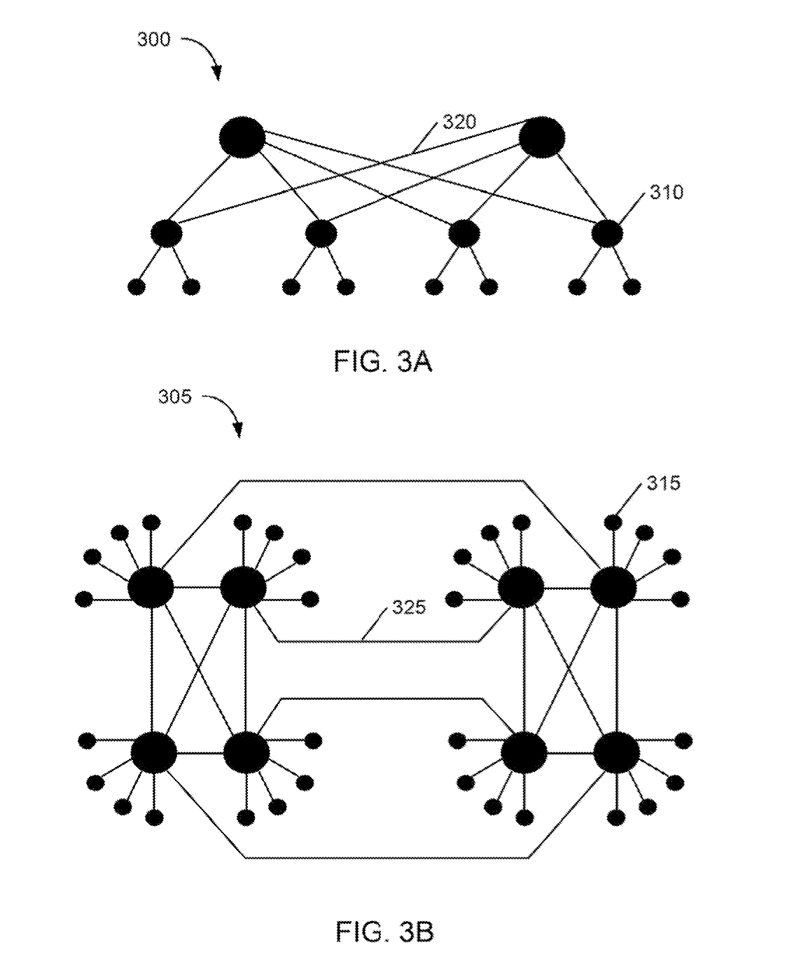

FIGS. 3A-B illustrate examples of network topologies. FIG. 3A illustrates a FatTree network topology 300 and FIG. 3B illustrates a HyperX network topology 305. Each node in the network topology (e.g., node 310 in FatTree 300 and node 315 in HyperX 305) may represent a network server, switch, or other component. The links between the nodes (e.g., link 320 in FatTree 300 and link 325 in HyperX 305) represent the connections between the servers, switches, and elements in the network. There can be multiple links between two network elements in a network topology. As appreciated by one skilled in the art, those links are physically implemented with cables in a physical topology (e.g., physical topology 200).

To determine how a network topology can be distributed in a physical topology such that the cabling costs are minimized, it is useful to model the network topology and the physical topology as undirected graphs. A network topology graph can be modeled with nodes representing the network elements in the network topology and a physical topology graph can be modeled with nodes representing physical elements or physical units in the physical topology. A mapping function to map the nodes in the network topology graph to the nodes in the physical topology graph can then be determined and its cost minimized. As described in more detail below, minimizing the mapping function cost minimizes the cost of the cables needed to assign network elements to physical elements or physical units, albeit at a high computational complexity that can be significantly reduced by hierarchically partitioning the network topology and the physical topology into matching levels.

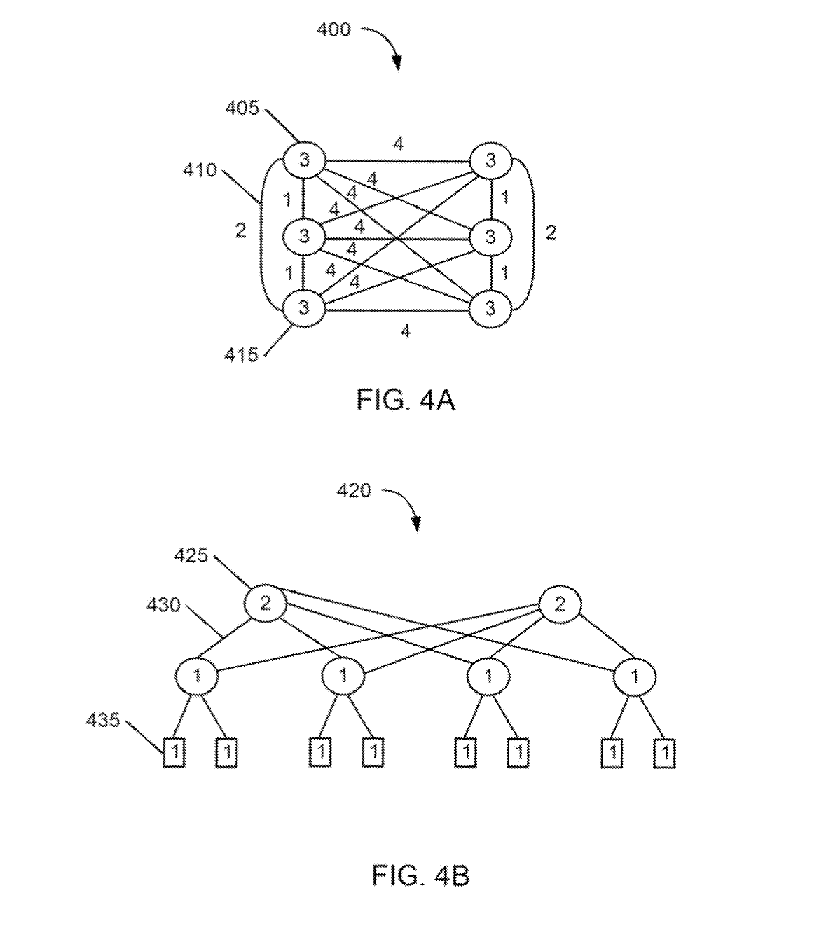

Referring now to FIG. 4A, an example of a physical topology graph is described. Physical topology graph 400 is shown with six nodes (e.g., node 405) and links between them (e.g., link 410). The six nodes may represent physical elements or physical units in a physical topology. The number inside each node may represent its capacity. For example, each node in physical topology graph 400 may represent a rack of a rack-based datacenter, and each rack may be able to accommodate three rack units (i.e., the number “3” inside each node denotes the 3 rack units for each of the 6 racks). Each link in the physical topology graph has a weight associated with it that denotes the distance between corresponding nodes. For example, link 410 has a weight of “2”, to indicate a distance of 2 between node 405 and node 415

FIG. 4B illustrates an example of a network topology graph. Network topology graph 420 is also shown with nodes (e.g., node 425) and links between them (e.g., link 430). The rectangular-shaped nodes (e.g., node 435) may be used to represent servers in the network and the circular-shaped nodes (e.g., node 425) may be used to represent network switches. Other network elements may also be represented in the network topology graph 420, which in this case is a two-level FatTree with 8 servers.

Datacenter switches and servers may come in different sizes and form factors. Typically, switches span standard-size rack widths but may be more than one rack unit in height. Servers may come in a variety of forms, but can be modeled as having a fraction of a rack unit. For example, for a configuration where two blade servers side-by-side occupy a rack unit, each blade server can be modeled as having a size of a half of a rack unit. To handle different sizes and form factors, each node in the network topology graph has a number associated with it that indicates the size (e.g., the height) of the network element represented in the node.

Given an arbitrary network topology graph G and an arbitrary physical topology graph H, a mapping function ƒ can be defined as a function that maps each node v in graph G to a subset of nodes ƒ(v) in H such that the following conditions hold true. First, the size of v—denoted by s(v)—is less than or equal to the total weight of nodes in the set ƒ(v), i.e.:

$$∀ v ∈ G , s ( v ) \leq {\sum }_{xef ( v )} {w}_{x} \qquad ( Eq . 1 )$$

where x is a node in the subset of nodes ƒ(v) and wₓ is the weight of node x. Second, if the size of v is greater than 1 (that is, a network element may span multiple physical units or elements), then ƒ(v) should consist of only nodes that are consecutive in the same physical element, i.e.:

∀vεG,∀i,jεƒ(v),pe(i)=pc(j) and |pu(i)−pu(j)|<|ƒ(v)| (Eq. 2)

where pe(·) is a function that maps a node in the physical topology graph to a corresponding physical element (e.g., rack) and pu(·) is a function that maps a node in the physical topology graph to a corresponding physical unit (e.g., rack unit). Lastly, no node in the physical topology graph should be overloaded, i.e.:

$$∀ h ∈ H , {\sum }_{{veV}_{h}} s ( v ) \leq {\sum }_{x ∈ {⋃}_{{veV}_{h}} f ( v )} {w}_{x} \\ where {V}_{h} = \{ v ∈ G \vert h ∈ f ( v ) \} . \qquad ( Eq . 3 )$$

The cost of a mapping function, denoted by cost(ƒ), may be defined as the sum over all links in the network topology graph G of the cost of the cables needed to realize those links in the physical topology under the mapping function ƒ. To accommodate nodes in G with a size greater than one, a function ƒ′ can be defined to compute the smallest physical unit (e.g., the lowest height rack unit) that is assigned to the node v, under a mapping function ƒ, that is: ƒ′(v)=arg min_{WGƒ(v)} pu(w). Thus, formally, the cost function cost(ƒ) can be defined as follows:

$$cost ( f ) = {\sum }_{( {v}_{1} , {v}_{2} ) ∈ G} d ( {f}^{′} ( {v}_{1} ) , {f}^{′} ( {v}_{2} ) ) + s ( {v}_{1} ) + s ( {v}_{2} ) - 2 \qquad ( Eq . 4 )$$

where d denotes a distance function between two physical units in the physical topology. It is appreciated that the sizes of the network elements v₁ and v₂ are added to the cost function cost(ƒ) as a cable may start and end anywhere on the faceplate of their respective physical elements.

In various embodiments, given an arbitrary network topology graph G and an arbitrary physical topology graph H, the goal is to find a mapping function ƒ that minimizes the cost function cost(ƒ), i.e., that minimizes the cabling costs in the network. As appreciated by one skilled in the art, it is computationally hard to solve this general problem of minimizing the cost function given the two arbitrary topology graphs. The computational complexity and problem size can be significantly reduced by hierarchically partitioning the physical and network topologies as described below.

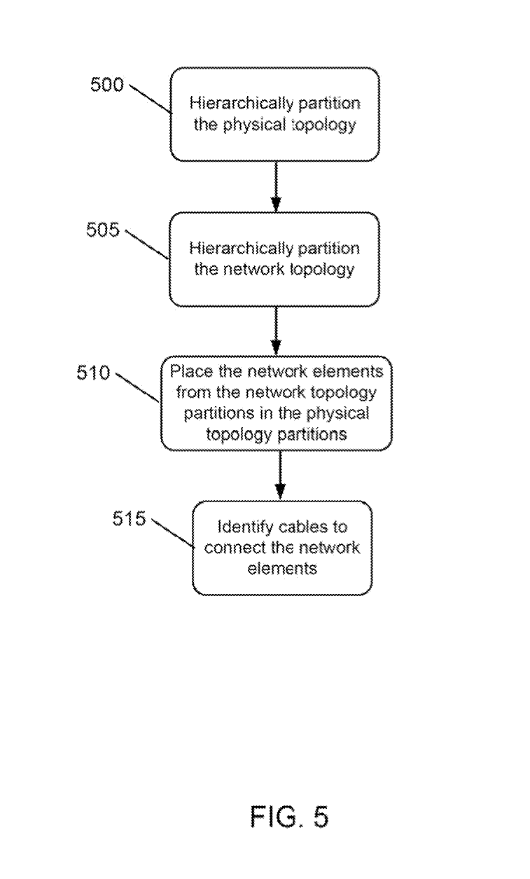

Referring now to FIG. 5, a flowchart for reducing cabling costs in a datacenter network is described. An assumption is made that there are a set of k available cable types with different cable lengths l₁, l₂, l₃, . . . , lₖ, where lᵢ<lⱼ for 1≦i≦j≦k. It is also assumed that lₖ can span any further physical units in a datacenter, that is, there is a cable available of length lₖ that can span the longest distance between two physical units in the datacenter. Further, it is assumed that longer cables cost more than shorter cables, as shown in Table I below listing prices for different Ethernet cables that support 10G and 40G of bandwidths.

TABLE I
Cable prices in dollars for various cable lengths

| | Single | Quad Channel | | |
|---|---|---|---|---|
| Length | Channel | QSFP | QSFP+ | QSFP+ |
| (m) | SFP+ copper | copper | copper | optical |
| 1 | 45 | 55 | 95 | — |
| 2 | 52 | 74 | — | — |
| 3 | 66 | 87 | 150 | 390 |
| 5 | 74 | 116 | — | 400 |
| 10 | 101 | — | — | 418 |
| 12 | 117 | — | — | — |
| 15 | — | — | — | 448 |
| 20 | — | — | — | 465 |
| 30 | — | — | — | 508 |
| 50 | — | — | — | 618 |
| 100 | — | — | — | 883 |

A key observation in minimizing the cabling costs of a datacenter network is that nodes (or sets of nodes) in the network topology that have dense connections (i.e., a larger number of links between them) should be placed physically close in the physical topology, so that lower cost cables can be used. Accordingly, to reduce cabling costs in a datacenter network, the physical topology is hierarchically partitioned into k levels such that the nodes within the same partition at a level i can be wired with cables of length lᵢ (500). Next, a matching hierarchical partitioning of the network topology into k levels is generated such that each partition of the network topology at a level i can be placed in a level i partition of the physical topology (505). While partitioning the network topology in different levels, the number of links that are included in the partitions (referred to herein as intra-partition links) is maximized. This ensures that the number of shorter cables used in the datacenter network is maximized.

Once the hierarchical partitions of the physical topology and the hierarchical partitions of the network topology are generated, the final step is the actual placement of network elements in the network topology partitions into the physical topology partitions (510). Cables are then identified to connect each of the network elements placed in the physical partitions (515). It is appreciated that the hierarchical partitioning of the physical topology exploits the proximity of nodes in the physical topology graph, while the hierarchical partitioning of the network topology exploits the connectivity of nodes in the network topology graph. As described above, the goal is to have nodes with dense connections placed physically close in the physical topology so that shorter cables can be used more often.

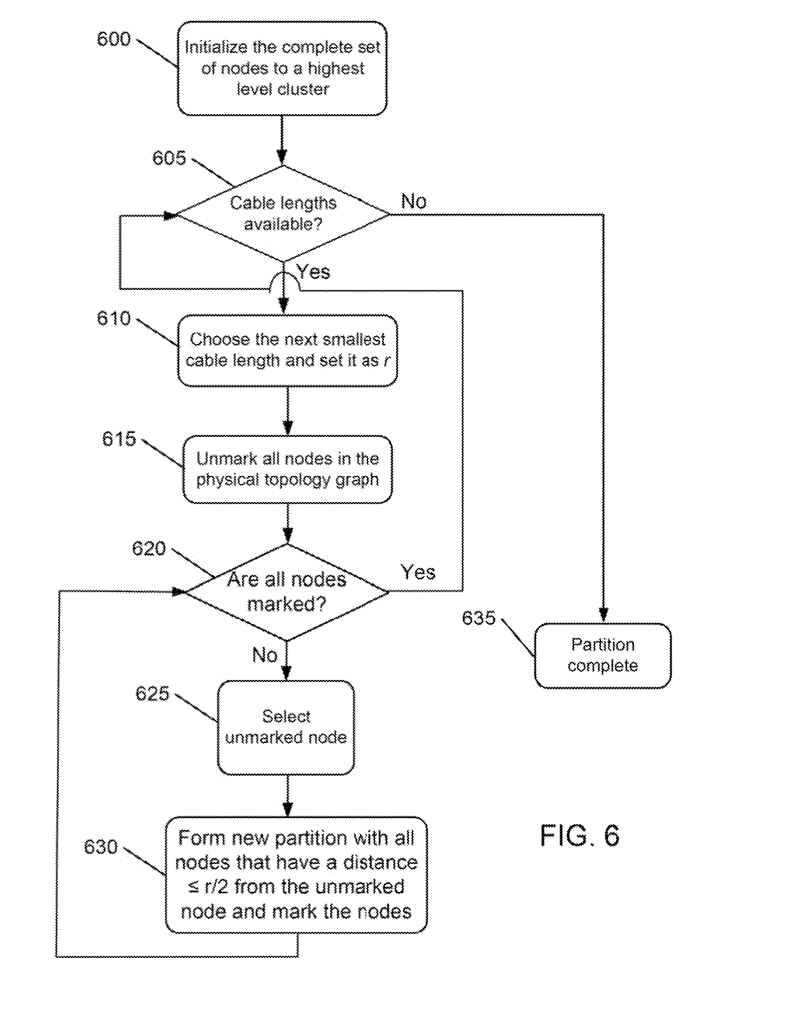

Attention is now directed to FIG. 6, which illustrates a flowchart for hierarchically partitioning a physical topology according to various embodiments. The hierarchical partitioning of the physical topology exploits the locality and proximity of physical elements and physical units. The goal is to identify a set of partitions or clusters such that any two physical units (e.g., rack units) within the same partition can be connected using cables of a specified length, but physical units in different partitions may require longer cables. The partitioning problem can be simplified by observing that physical units within the same physical element can be connected using short cables. For example, any two rack units in a rack may use cables of length of at most 3 meters. That is, all physical units within a given physical element can be placed in the same partition.

To exploit this, a physical topology graph can be generated by having physical elements instead of physical units as nodes. A capacity can be associated with each node to denote the number of physical units in the physical element represented by the node. The weight of a link between two nodes can be set as the length of the cable required to wire between the bottom physical units of their corresponding physical elements.

The hierarchical partitioning of the physical topology is based on the notion of r-decompositions. For a parameter r, an r-decomposition of a weighted graph H is a partition of the nodes of H into clusters or partitions, with each partition having a diameter of at most r. Given a physical topology graph, its set of clusters C, and the length of the cables available {l₁, . . . , lₖ}, the partitioning of the physical topology forms clusters or partitions of a diameter of at most lᵢ for a given partition i. The partitioning starts by initializing the complete set of nodes in the physical topology graph to be a single highest level cluster (600). It then, recursively for each given cable length starting at the longest cable length in decreasing order, partitions each cluster at the higher level into smaller clusters that have a diameter of at most the length of the cable used to partition at that level.

The partitioning checks after each cluster is formed whether there are any other cable lengths available (605), that is, whether the partition should proceed to form smaller clusters or whether the partition should be considered complete (635). If there are cable lengths available, the first steps are to select the next smallest cable length as the diameter r for the r-decomposition (610) and unmark all nodes in the physical topology graph (615). While not all nodes in the graph are marked (620), an unmarked node u is selected (625) and a set C={vεV(H)|v unmarked; d(u,v)≦r/2} is generated, where d(·) is a distance function as described above. All nodes in the set C are then marked and a new cluster or partition is formed with a diameter of at most the length of the cable used to partition at that level (630). The partitioning continues for all cable lengths available.

More formally, for generating clusters of a diameter l₁, the hierarchical partitioning computes the l₁-decomposition for each cluster at level l+1. It is appreciated that the lowest level partitions (i.e., l₁=0) correspond to a single physical element in the physical topology. It is also appreciated that the hierarchical partitioning of the physical topology is oblivious to the actual structure of the physical space—separation between physical elements, aisle widths, how cable trays run across the physical elements, and so on. As long as there is a meaningful way to define a distance function d(·) and the corresponding distances adhere to the requirement of the underlying r-decompositions, the physical topology can be hierarchically partitioned.

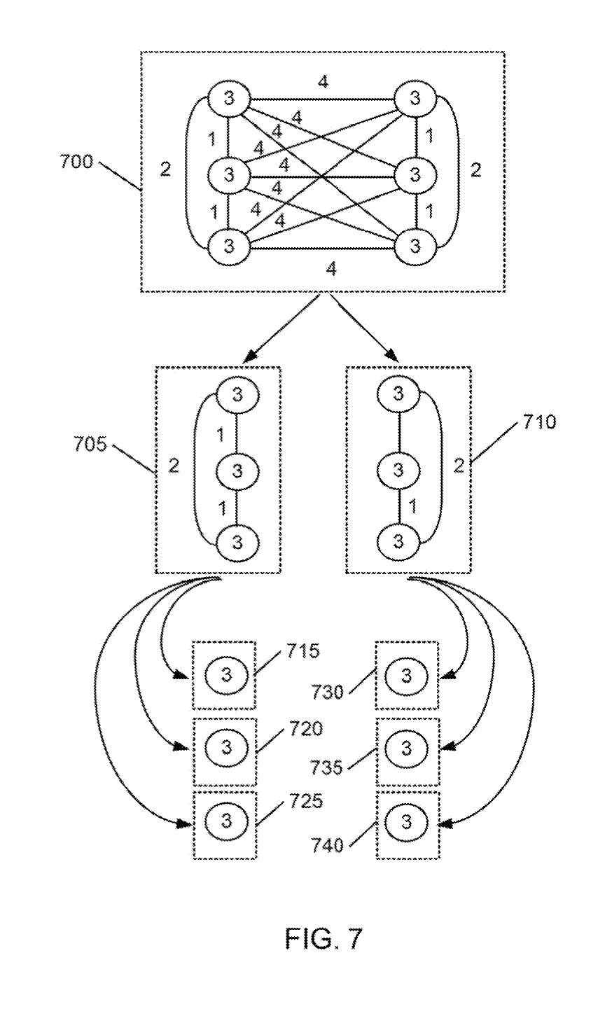

FIG. 7 illustrates an example of hierarchical partitioning of a physical topology represented by the physical topology graph of FIG. 4A. Physical topology graph 700 has six nodes representing physical elements in a physical topology. Each physical element has 3 physical units, as denoted by the capacity of each node. The physical topology graph 700 is first hierarchically partitioned into partitions 705 and 710, which in turn are respectively partitioned into partitions 715-725 and 730-740. Note that the last partitions 715-740 are all down to a single physical element to increase the use of shorter cables within these partitions.

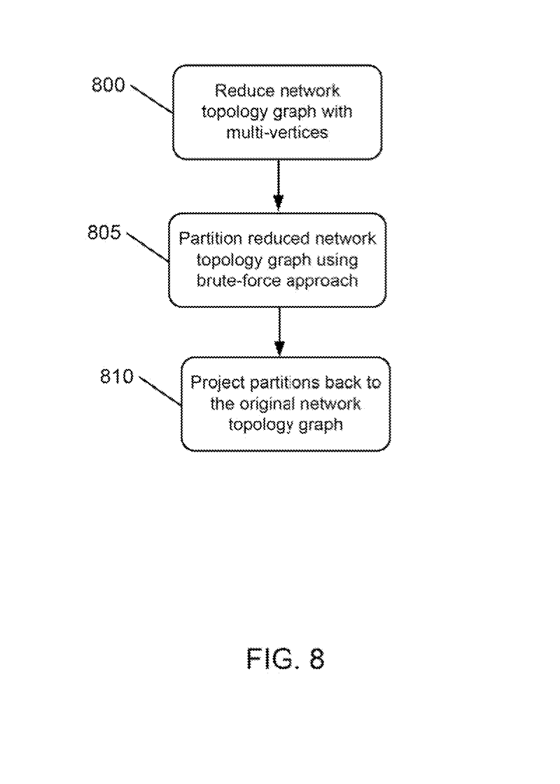

Attention is now directed to FIG. 8, which illustrates a flowchart for hierarchically partitioning a network topology according to various embodiments. In contrast to the partitioning technique of the physical topology (shown in FIG. 6) that exploited the proximity of the physical elements and physical units in the physical topology, the technique for partitioning the network topology generates partitions such that nodes within a single partition are expected to be densely connected. That is, the partitioning of the physical topology exploits the proximity of the physical elements and physical units, while the partitioning of the network topology exploits the density of the connections or links between network elements in the network topology. The idea is to put those network elements with lots of connections to other network elements closer together in space so that shorter (and thus cheaper) cables can be used in the datacenter network.

As described above with reference to FIG. 4B, the network topology is modeled as an arbitrary weighted undirected graph G, with each edge having a weight representing the number of links between the corresponding nodes. Note that there are no assumptions made on the structure of the network topology; this allows placement algorithms to be designed for a fairly general setting, irrespective of whether the network topology has a structure (e.g., FatTree, HyperX, etc.) or is completely unstructured (e.g., random). One skilled in the art appreciates that it may be possible to exploit the structure of the network topology for improved placement.

Given a hierarchical partitioning Pp of the physical topology, the goal is to generate a matching hierarchical partitioning of the network topology P₁, while minimizing the cumulative weight of the inter-partition edges at each level. A hierarchical partition P₁ matches another hierarchical partition Pp if they have the same number of levels and there exists an injective mapping of each partition p₁ at each level l in Pₗ to a partition p₂ at level l in Pp such that the size of p₂ is greater than or equal to the size of p₁.

Accordingly, matching partitions for the network topology are generated in a top-down recursive fashion. At each level, several partitioning sub-problems are solved. At the top most level, only one partitioning sub-problem is solved: to partition the whole network topology into partitions that matches the partitions of the physical topology at the top level. At other levels, as many partitioning sub-problems are run as there are network node partitions.

The partitioning sub-problem can be defined as follows. Suppose p₁, p₂, . . . , pₖ are the sizes of ₖ partitions that are targeted to match a physical partition during a partitioning sub-problem. Given a connected, weighted undirected graph L=(V(L), E(L)), where V are the vertices and E are the edges, partition V(L) into clusters V₁, V₂, . . . , Vₖ such that V₁∩Vⱼ=Ø for i≠j, |Vᵢ|≦pᵢ, and ∪Vᵢ=V(L) such that the weight of edges in the edge-cut (defined as the set of edges that have end points in different partitions) is minimized. Although the partitioning problem is known to be NP-hard, there are a number of algorithms that have been designed due to its applications in the VLSI design, multiprocessor scheduling, and load balancing fields. The main technique used in these algorithms is multilevel recursive partitioning.

In various embodiments, the hierarchical partitioning of the network topology generates efficient partitions by exploiting multilevel recursive partitioning along with several heuristics to improve the initial set of partitions. The hierarchical partitioning of the network topology has three steps. First, the size of the graph is reduced in such a way that the edge-cut in the smaller graph approximates the edge-cut in the original graph (800). This is achieved by collapsing the vertices that are expected to be in the same partition into a multi-vertex. The weight of the multi-vertex is the sum of the weights of the vertices that constitute the multi-vertex. The weight of the edges incident to a multi-vertex is the sum of the weights of the edges incident on the vertices of the multi-vertex. Using such a technique allows the size of the graph to be reduced without distorting the edge-cut size, that is, the edge-cut size for partitions of the smaller instance should be equal to the edge-cut size of the corresponding partitions in the original problem.

In order to collapse the vertices, a heavy-weight matching heuristic is implemented. In this heuristic, a maximal matching of maximum weight is computed using a randomized algorithm and the vertices that are the end points of the edges in the computed matching are collapsed. The new reduced graph generated by the first step is then partitioned using a brute-force technique (805). Note that since the size of the new graph is sufficiently small, a brute-force approach leads to efficient partitions within a reasonable amount of processing time. In order to match the partition sizes, a greedy algorithm is used to partition the smaller graph. In particular, the algorithm starts with an arbitrarily chosen vertex and grows a region around the vertex in a breadth-first fashion, until the size of the region corresponds to the desired size of the partition. Since the quality of the edge-cut of so obtained partitions is sensitive to the selection of the initial vertex, several iterations of the algorithm are run and the solution that has the minimum edge-cut size is selected.

Lastly, the partitions thus generated are projected back to the original graph (810). During the projection phase, another optimization technique is used to improve the quality of partitioning. In particular, the partitions are further refined using the Kernighan-Lin algorithm, a heuristic often used for graph partitioning with the objective of minimizing the edge-cut size. Starting with an initial partition, the algorithm in each step searches for a subset of vertices, from each part of the graph such that swapping these vertices leads to a partition with a smaller edge-cut size. The algorithm terminates when no such subset of vertices can be found or a specified number of swaps have been performed.

It is appreciated that one implementation issue that may arise with this hierarchical partitioning of the network topology is that the number of nodes in the input network topology graph should be equal to the sum of the sizes of the partitions specified in the input. This can cause a potential inconsistency because the desired size of the partitions (i.e., generated by partitioning the physical topology) are a factor of the size of the physical elements and physical units, which may have little correspondence to the number of network elements required in the network topology. In order to overcome this issue, extra nodes may be added to the network topology. These extra nodes are set to have no outgoing edges and a weight of 1. After completion of the placement step (515 in FIG. 5), these extra nodes correspond to unused physical units or physical elements that they are assigned to.

Another implementation issue that may arise is that the partitions generated may have sizes that are an approximation and not exact to the partition sizes generated by partitioning the physical topology. This may lead to consistency problems when mapping the network topology on to the physical topology. In order to overcome this issue, a simple Kernighan-Lin style technique may be used to balance the partitions. For each node in a partition A that has a larger size than desired, the cost of moving the node to a partition B that has a smaller size than desired is computed. This cost is defined as the increase in the number of inter-cluster edges if the node were moved from A to B. The node may then be moved with the minimum cost from A to B. Since all nodes have unit weights during the partitioning phase, this ensures that the partitions are balanced.

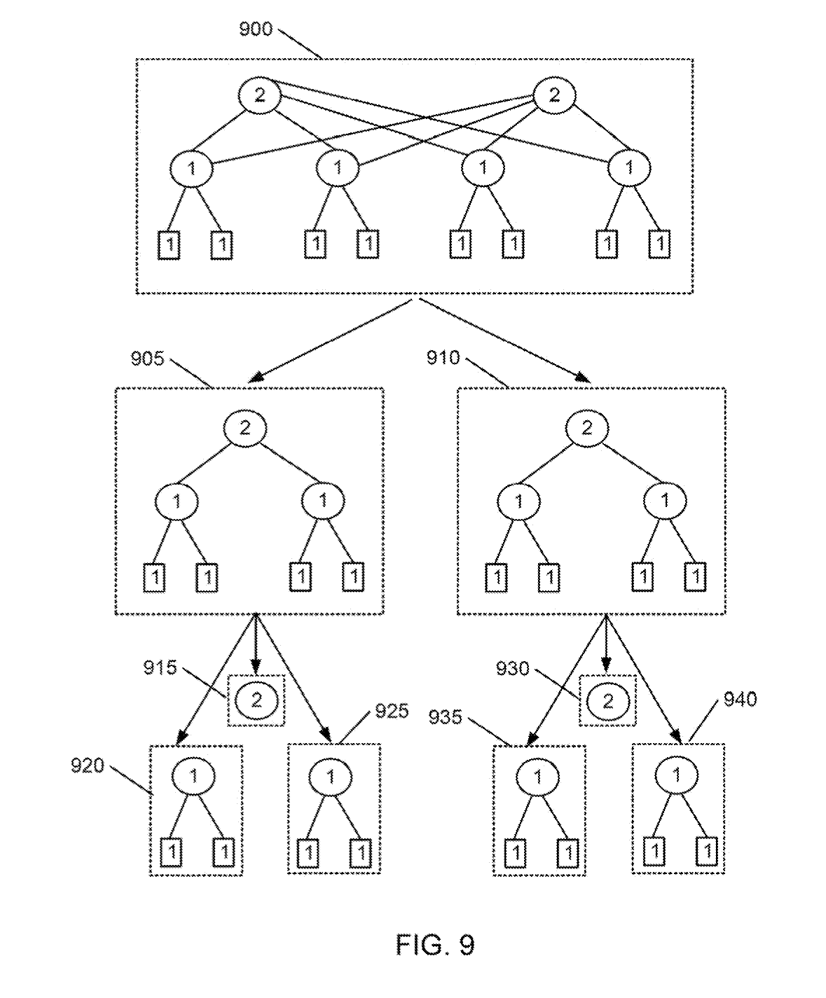

FIG. 9 illustrates an example of a hierarchical partitioning of a network topology matching the hierarchical partitioning of a physical topology of FIG. 7. Network topology graph 900 is first hierarchically partitioned into partitions 905 and 910, which in turn are respectively partitioned into partitions 915-925 and 930-940. Note that the partitions 915 and 930 are down to a single network element of a size 2, while partitions 920-925 and 935-940 have 3 network elements each, all with a size of 1. These six partitions 915-925 and 930-940 are to match the physical topology partitions 715-725 and 730-740 of FIG. 7. Each of these physical topology partitions have physical elements of a weight of 3, thereby being able to fit a single network element of a size 2 (partitions 915 and 930) or three network elements of size 1 each (partitions 920-925 and 935-940).

Once a matching hierarchical partitioning is identified for the network topology, there are two remaining tasks before determining the exact locations in the physical topology for each network element in the network topology. First, the network elements assigned to a physical element need to be placed in a physical unit within the element. Second, the exact cables needed to connect all network elements in the network topology need to be identified and the costs of using them need to be computed.

The first step is performed because, as described above, to simplify the hierarchical partitioning of the physical topology, the physical topology graph had nodes at the granularity of physical elements rather than physical units. As a result, the network topology partitioning essentially assigns each node in the network topology to a physical element. This assignment is many-to-one, that is, several nodes (i.e., network elements) in the network topology may be assigned to the same physical element. The next step is to place these network elements from the network topology partitions in the physical topology partitions (510 in FIG. 5).

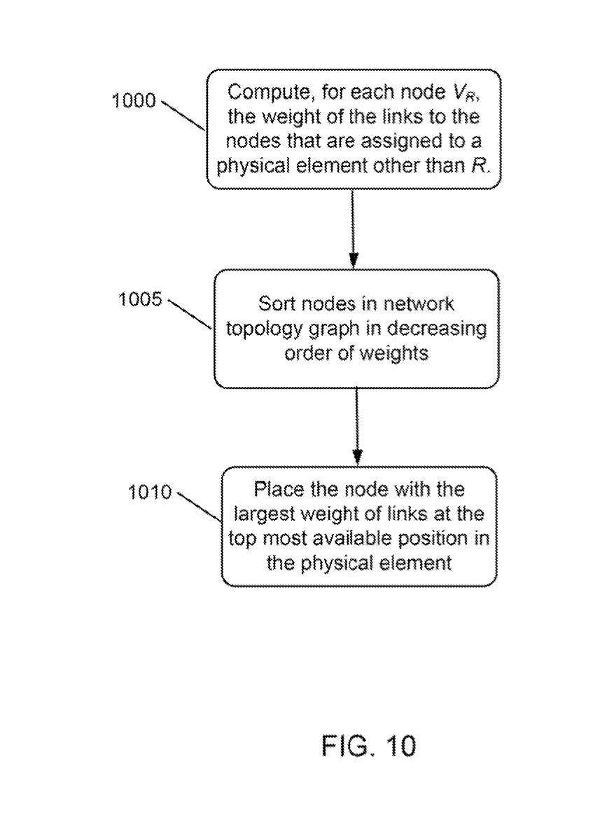

Attention is now directed to FIG. 10, which illustrates a flowchart for the placement of network elements from the network topology partitions in the physical topology partitions. As appreciated by one skilled in the art and as described above, some physical topology configurations (e.g., rack-based) may have cables running between two physical elements at the top of the physical elements (e.g., in a cable ceiling-hung tray). Hence, to reduce the cable length, network elements that have more links to network elements in other partitions may be placed at the top of their assigned physical element.

The placement of network elements takes as input the network topology graph G, a physical element R and a set of nodes V_{R} that are assigned to physical element R. The first step is to compute, for each node in V_{R}, the weight of the links to the nodes that are assigned to a physical element other than R (1000). For any node vεV_{R}, given the network topology and the set V_{R}, this can be easily computed by iterating over the set of edges incident on v, and checking if the other end of the edge is in V_{R} or not. Once the weight of links to nodes on other physical elements is computed for each node, the nodes are sorted in decreasing order of these weights (1005). The node, among the remaining nodes, with the maximum weight of links to other physical elements is then placed at the top most available position on the physical element (1010).

One skilled in the art appreciates that placing the node at the top most available position on the physical element may not be the best placement for certain physical topology configurations. In those cases, other placements may be used, keeping in mind the overall goat of maximizing the use of shorter cables and thus minimizing the total cabling costs. Once matching partitions are generated and placement is decided, determining the cable to use to connect each link in the network topology becomes straightforward. After partitioning and placement, a unique physical unit or element in the physical topology is assigned for each node in the network topology.

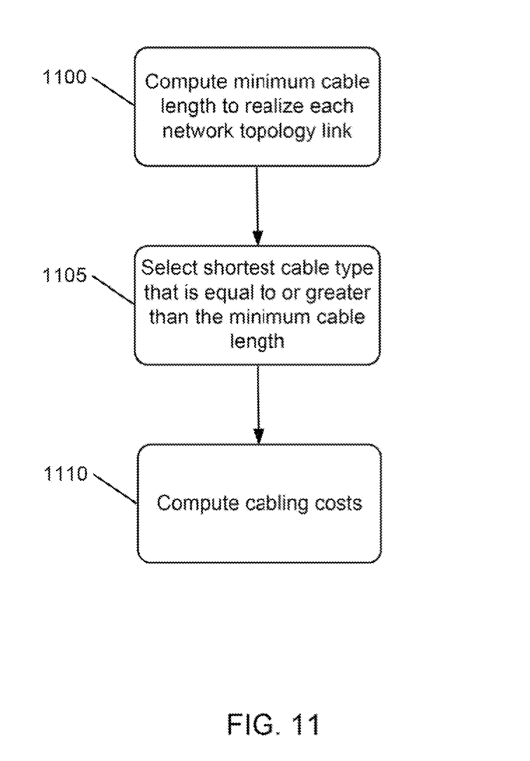

Referring now to FIG. 11, a flowchart for identifying cables to connect the network elements placed in the physical partitions is described. First, the minimum length of the cable needed to realize each link of the network topology is computed using the distance function d(·), as described above (1100). Then the shortest cable type from the set of cable types l₁, l₂, . . . , lₖ that is equal to or greater than the minimum cable required is selected (1105). The price for this cable is used in computing the total cabling cost (1110). One aspect to note is that the cabling is decided based on the final placement of the nodes and not based on how partitioning is done. Observe that two network topology nodes that have a link between them and are in different partitions at a level i may indeed be finally wired with a cable of length lⱼ<lᵢ.

Advantageously, the network design module 100 of FIG. 1 for reducing cabling costs as described above can adapt to many different physical and network topologies and may be used as part of an effective datacenter network design strategy before applying topology-specific optimizations. The network design module 100 enables cabling costs to be significantly reduced (e.g., about 38% reduction in comparison to a greedy approach) and allows datacenter designers to have an automated and cost-effective way to design cabling layouts, a task that is traditionally performed manually.

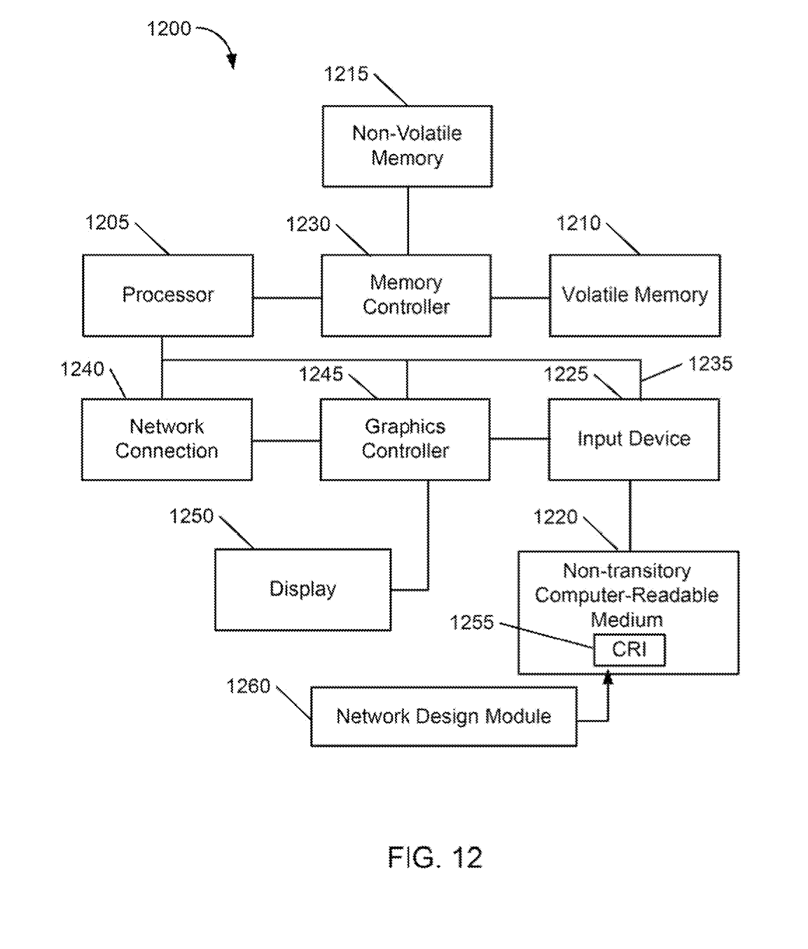

The network design module 100 can be implemented in hardware, software, or a combination of both. FIG. 12 illustrates a component for implementing the network design module of FIG. 1 according to the present disclosure is described. The component 1200 can include a processor 1205 and memory resources, such as, for example, the volatile memory 1210 and/or the non-volatile memory 1215, for executing instructions stored in a tangible non-transitory medium (e.g., volatile memory 1210, non-volatile memory 1215, and/or computer readable medium 1220). The non-transitory computer-readable medium 1220 can have computer-readable instructions 1255 stored thereon that are executed by the processor 1205 to implement a Network Design Module 1260 according to the present disclosure.

A machine (e.g., a computing device) can include and/or receive a tangible non-transitory computer-readable medium 1220 storing a set of computer-readable instructions (e.g., software) via an input device 1225. As used herein, the processor 1205 can include one or a plurality of processors such as in a parallel processing system. The memory can include memory addressable by the processor 1205 for execution of computer readable instructions. The computer readable medium 1220 can include volatile and/or non-volatile memory such as a random access memory (“RAM”), magnetic memory such as a hard disk, floppy disk, and/or tape memory, a solid state drive (“SSD”), flash memory, phase change memory, and so on. In some embodiments, the non-volatile memory 1215 can be a local or remote database including a plurality of physical non-volatile memory devices.

The processor 1205 can control the overall operation of the component 1200. The processor 1205 can be connected to a memory controller 1230, which can read and/or write data from and/or to volatile memory 1210 (e.g., RAM). The processor 1205 can be connected to a bus 1235 to provide communication between the processor 1205, the network connection 1240, and other portions of the component 1200. The non-volatile memory 1215 can provide persistent data storage for the component 1200. Further, the graphics controller 1245 can connect to an optional display 1250.

Each component 1200 can include a computing device including control circuitry such as a processor, a state machine, ASIC, controller, and/or similar machine. As used herein, the indefinite articles “a” and/or “an” can indicate one or more than one of the named object. Thus, for example, “a processor” can include one or more than one processor, such as in a multi-core processor, cluster, or parallel processing arrangement.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. For example, it is appreciated that the present disclosure is not limited to a particular configuration, such as component 1200.

Those of skill in the art would further appreciate that the various illustrative modules and steps described in connection with the embodiments disclosed herein may be implemented as electronic hardware, computer software, or combinations of both. For example, the example steps of FIGS. 5, 6, 8, 10, and 11 may be implemented using software modules, hardware modules or components, or a combination of software and hardware modules or components. Thus, in one embodiment, one or more of the example steps of FIGS. 5, 6, 8, 10, and 11 may comprise hardware modules or components. In another embodiment, one or more of the steps of FIGS. 5, 6, 8, 10, and 11 may comprise software code stored on a computer readable storage medium, which is executable by a processor.

To clearly illustrate this interchangeability of hardware and software, various illustrative components, blocks, modules, and steps have been described above generally in terms of their functionality (e.g., the Network Design Module 1260). Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present disclosure.

What is claimed is:

1. A datacenter network with reduced cabling costs, comprising:
a network topology to interconnect a plurality of network elements; and
a network design module to assign network elements to a plurality of physical elements and physical units in a physical topology based on a hierarchical partitioning of the physical topology and a matching hierarchical partitioning of the network topology that reduces costs of cables used to interconnect the network elements in the physical topology.

3. The datacenter network of claim 1, wherein the network topology comprises an arbitrary connection of network elements, comprising of, but not limited to, a FatTree topology, a HyperX topology, a BCube topology, a DCell topology and a CamCube topology.

4. The datacenter network of claim 1, wherein the physical topology is a rack-based physical topology having a plurality of racks as the plurality of physical elements and a plurality of rack units as the plurality of physical units.

5. The datacenter network of claim 1, wherein the hierarchical partitioning of the physical topology is based on a r-decomposition of a physical topology graph representing the physical topology, wherein r is a cable length associated with a partition.

6. The datacenter network of claim 1, wherein the matching hierarchical partitioning of the network topology is generated to minimize a weight of links interconnecting the plurality of network elements in a network topology graph representing the network topology.

7. The datacenter network of claim 1, wherein physical units within a single physical element are placed in a single partition of the physical topology.

8. The datacenter network of claim 1, wherein network elements assigned to a single partition of the physical topology are connected with a single length cable.

9. The datacenter network of claim 1, wherein the network design module assigns shorter cables to more densely connected network elements.

10. A method for reducing cabling costs in a datacenter network, comprising:
hierarchically partitioning a physical topology organized into a plurality of physical elements and physical units;
hierarchically partitioning a network topology interconnecting a plurality of network elements to match the hierarchical partitioning of the physical topology;
placing the plurality of network elements from the network topology in the physical topology based on the hierarchical partitioning of the physical topology and the matching hierarchical partitioning of the network topology; and
identifying cables to connect the plurality of network elements to reduce cabling costs.

11. The method of claim 10, wherein hierarchically partitioning the physical topology comprises generating a plurality of levels of partitions of the physical topology such that a partition at a level l uses l-th shortest cables among a set of cables.

12. The method of claim 10, wherein hierarchically partitioning the physical topology comprises generating an r-decomposition of a physical topology graph representing the physical topology, wherein r is a cable length associated with a partition.

13. The method of claim 10, wherein hierarchically partitioning the network topology comprises generating a plurality of levels of partitions of the network topology matching the plurality of levels of partitions of the physical topology.

14. The method of claim 10, wherein placing the plurality of network elements from the network topology in the physical topology comprises placing network elements in a level l partition of the network topology into a level l partition of the physical topology.

15. The method of claim 10, wherein placing the plurality of network elements from the network topology in the physical topology comprises placing densely connected network elements at a top partition of the physical topology.

16. A non-transitory computer readable medium having instructions stored thereon executable by a processor to:
represent a network topology interconnecting a plurality of network elements with a network topology graph;
represent a physical topology organized into a plurality of physical elements and physical units with a physical topology graph;
hierarchically partition the physical topology graph;
generate a matching hierarchical partition of the network topology graph;
place the plurality of network elements in the plurality of physical units and physical elements based on the hierarchical partition of the physical topology graph and the hierarchical partition of the network topology; and
determine a set of cables to interconnect the plurality of network elements in the plurality of physical units and physical elements that reduce cabling costs.

17. The non-transitory computer readable medium of claim 16, wherein the instructions to hierarchically partition the physical topology graph comprise instructions to generate a plurality of levels of partitions of the physical topology graph such that a partition at a level l uses l-th shortest cables among a set of cables.

18. The non-transitory computer readable medium of claim 16, wherein the instructions to generate a matching hierarchical partition of the network topology graph comprise instructions to generate a plurality of levels of partitions of the network topology graph matching the plurality of levels of partitions of the physical topology graph.

19. The non-transitory computer readable medium of claim 16, wherein the instructions to place the plurality of network elements in the plurality of physical units and physical elements comprise instructions to place network elements in a level l partition of the network topology graph into a level l partition of the physical topology.

20. The non-transitory computer readable medium of claim 16, wherein the instructions to place the plurality of network elements in the plurality of physical units and physical elements comprise instructions to place densely connected network elements at a top partition of the physical topology.
